(19) United States
(12) Patent Application Publication
(10) Pub. No.: US 2014/0032209 A1
(43) Pub. Date: Jan. 30, 2014

(54) OPEN INFORMATION EXTRACTION

(71) Applicant: University of Washington through its Center for Commercialization, Seattle, WA (US)

(72) Inventors: Oren Etzioni, Seattle, WA (US); Michael Cafarella, Ann Arbor, MI (US); Michele Banko, Seattle, WA (US)

(21) Appl. No.: 13/952,468

(22) Filed: Jul. 26, 2013

Related U.S. Application Data
(60) Provisional application No. 61/676,579, filed on Jul. 27, 2012.

(51) Int. Cl. G06F 17/27

(52) U.S. Cl. CPC G06F 17/277
USPC 704/9

(57) ABSTRACT

A system for identifying relational tuples is provided. The system extracts a relation phrase from a sentence by identifying a verb in the sentence and then identifying a relation phrase of the sentence as a phrase in the sentence starting with the identified verb that satisfies both a syntactic constraint and a lexical constraint. The system also identifies arguments for a relation phrase. To extract the arguments, the system applies a left-argument-left-bound classifier, a left-argument-right-bound classifier, and a right-argument-right-bound classifier to identify a left argument and right argument for the relation phrase such that the left argument, the relation phrase, and the right argument form a relational tuple.

### CROSS-REFERENCE TO RELATED APPLICATION

This application claims the benefit of U.S. Provisional Patent Application No. 61/676,579 (Attorney Docket No. 72227-8061.US01) filed Jul. 27, 2012, entitled TEXTRUNNER, which is incorporated herein by reference in its entirety.

### BACKGROUND

Ever since its invention, text has been the fundamental repository of human knowledge and understanding. With the invention of the printing press, the computer, and the explosive growth of the Web, the amount of readily accessible text has long surpassed the ability of humans to read it. This challenge has only become worse with the explosive popularity of new text production engines such as Twitter where hundreds of millions of short “texts” are created daily [Ritter et al., 2011]. Even finding relevant text has become increasingly challenging. Clearly, automatic text understanding has the potential to help, but the relevant technologies have to scale to the Web.

Starting in 2003, the KnowItAll project at the University of Washington has sought to extract high-quality collections of assertions from massive Web corpora. In 2006, it was noted that: “The time is ripe for the Al community to set its sights on Machine Reading—the automatic, unsupervised understanding of text.” [Etzioni et al., 2006]. In response to the challenge of Machine Reading, the Open Information Extraction (Open IE) paradigm, which aims to scale IE methods to the size and diversity of the Web corpus, was investigated [Banko et al., 2007].

Typically, Information Extraction (IE) systems learn an extractor for each target relation from labeled training examples [Kim and Moldovan, 1993; Riloff, 1996; Soderland, 1999]. This approach to IE does not scale to corpora where the number of target relations is very large, or where the target relations cannot be specified in advance. Open IE solves this problem by identifying relation phrases—phrases that denote relations in English sentences [Banko et al., 2007]. The automatic identification of relation phrases enables the extraction of arbitrary relations from sentences, obviating the restriction to a pre-specified vocabulary.

Open IE systems avoid specific nouns and verbs at all costs. The extractors are unlexicalized—formulated only in terms of syntactic tokens (e.g., part-of-speech tags) and closed-word classes (e.g., of, in, such as). Thus, Open IE extractors focus on generic ways in which relationships are expressed in English—naturally generalizing across domains.

Open IE systems have achieved a notable measure of success on massive, open-domain corpora drawn from the Web, Wikipedia, and elsewhere. [Banko et al., 2007; Wu and Weld, 2010; Zhu et al., 2009]. The output of Open IE systems has been used to support tasks like learning selectional preferences [Ritter et al., 2010], acquiring common-sense knowledge [Lin et al., 2010], and recognizing entailment rules [Schoenmackers et al., 2010; Berant et al., 2011]. In addition, Open IE extractions have been mapped onto existing ontologies [Soderland et al., 2010].

Open IE systems make a single (or constant number of) pass(es) over a corpus and extract a large number of relational tuples (Arg1, Pred, Arg2) without requiring any relation-specific training data. For instance, given the sentence, “McCain fought hard against Obama, but finally lost the election,” an Open IE system should extract two tuples, (McCain, fought against, Obama), and (McCain, lost, the election). The strength of Open IE systems is in their efficient processing as well as ability to extract an unbounded number of relations.

Several Open IE systems have been proposed before now, including TEXTRUNNER [Banko et al., 2007], WOE [Wu and Weld, 2010], and StatSnowBall [Zhu et al., 2009]. All these systems use the following three-step method:
1. Label: Sentences are automatically labeled with extractions using heuristics or distant supervision.
2. Learn: A relation phrase extractor is learned using a sequence-labeling graphical model (e.g., CRF).
3. Extract: the system takes a sentence as input, identifies a candidate pair of NP arguments (Arg1, Arg2) from the sentence, and then uses the learned extractor to label each word between the two arguments as part of the relation phrase or not.
   The extractor is applied to the successive sentences in the corpus, and the resulting extractions are collected.

The first Open IE system was TEXTRUNNER [Banko et al., 2007], which used a Naive Bayes model with unlexicalized part-of-speech (“POS”) and NP-chunk features, trained using examples heuristically generated from the Penn Treebank. Subsequent work showed that utilizing a linear-chain CRF [Banko and Etzioni, 2008] or Markov Logic Network [Zhu et al., 2009] can lead to improved extractions. The WOE systems made use of Wikipedia as a source of training data for their extractors, which leads to further improvements over TEXTRUNNER [Wu and Weld, 2010]. They also show that dependency parse features result in a dramatic increase in precision and recall over shallow linguistic features, but at the cost of extraction speed.

All prior Open IE systems have two significant problems: in incoherent extractions and uninformative extractions. Incoherent extractions are cases where the extracted relation phrase has no meaningful interpretation.

TABLE 1

| Sentence | Incoherent Relation |
|---|---|
| The guide contains dead links | contains omits |
| and omits sites. | |
| The Mark 14 was central to the | was central torpedo |
| torpedo scandal of the fleet. | |
| They recalled that Nungesser | Recalled began |
| began his career as a precinct | |
| leader. | |

Table 1 provides examples of incoherent extractions. Incoherent extractions make up approximately 13% of TEXTRUNNER's output, 15% of WOE^{pos}'s output, and 30% of WOE^{parse}'s output. Incoherent extractions arise because the learned extractor makes a sequence of decisions about whether to include each word in the relation phrase, often resulting in incomprehensible relation phrases.

The second problem, uninformative extractions, occurs when extractions omit critical information. For example, consider the sentence “Hamas claimed responsibility for the Gaza attack.” Previous Open IE systems return the uninformative: (Hamas, claimed, responsibility) instead of (Hamas, claimed responsibility for, the Gaza attack). This type of error is caused by improper handling of light verb constructions (LVCs). An LVC is a multi-word predicate composed of a verb and a noun, with the noun carrying the semantic content of the predicate [Grefenstette and Teufel, 1995; Stevenson et al., 2004; Allerton, 2002]. Table 2 illustrates the wide range of relations expressed with LVCs, which are not captured by previous open extractors.

TABLE 2

| | |
|---|---|
| is | is an album by, is the author of, is a city in |
| has | has a population of, has a Ph.D. in, has a cameo in |
| made | made a deal with, made a promise to |
| took | took place in, took control over, took advantage of |
| gave | gave birth to, gave a talk at, gave new meaning to |
| got | got tickets to see, got a deal on, got funding from |

Table 2 provides examples of uninformative relations (left) and their completions (right). Uninformative extractions account for approximately 4% of WOE^{parse}'s output, 6% of WOE^{pos}'s output, and 7% of TEXTRUNNER's output.

### BRIEF DESCRIPTION OF THE DRAWINGS

FIG. 1 is a block diagram that illustrates components of REVERB in some embodiments.

FIG. 2 is a block diagram that illustrates components of ARGLEARNER in some embodiments.

FIG. 3 is a flow diagram that illustrates the processing of an extraction component of ReVerb in some embodiments.

### DETAILED DESCRIPTION

A method and system for extracting a relation phrase from a sentence having words is provided. In some embodiments, the system (”REVERB”) identifies a verb in the sentence and then identifies a relation phrase of the sentence as a phrase in the sentence starting with the identified verb that satisfies a relation phrase constraint. The relation phrase constraint may include a syntactic constraint and a lexical constraint. The syntactic constraint is defined as a POS-based regular expression for reducing extraction of incoherent and uninformative relation phrases. A relation phrase satisfies the syntactic constraint when the relation phrase matches the POS-based regular expression. The lexical constraint is defined as a dictionary of relation phrases for reducing extraction of uninformative relation phrases. A relation phrase satisfies the lexical constraint when the relation phrase is in the dictionary.

In some embodiments, the system (“ARGLEARNER”) identifies arguments for a relation phrase in a sentence of words. The system includes a left-argument-left-bound classifier, a left-argument-right-bound classifier, a right-argument-right-bound classifier, and an argument extractor. The left-argument-left-bound classifier inputs features associated with a phrase and generates a score based on those features indicating whether the phrase includes a left bound of a noun phrase of a left argument. The left-argument-right-bound classifier inputs features associated with a phrase and generates a score based on those features indicating whether the phrase includes a right bound of a noun phrase of a left argument. The right-argument-right-bound classifier inputs features associated with a phrase and generates a score based on those features indicating whether the phrase includes a right bound of a noun phrase of a right argument. The argument extractor applies the left-argument-left-bound classifier, the left-argument-right-bound classifier, and the right-argument-right-bound classifier to the sentence to identify a left argument and right argument for the relation phrase such that the left argument, the relation phrase, and the right argument form the relational tuple.

REVERB implements a general model of verb-based relation phrases expressed as two simple constraints: a syntactic constraint and a lexical constraint. These constraints are described first followed by a description of the REVERB architecture.

The syntactic constraint serves two purposes. First, it eliminates incoherent extractions, and second, it reduces uninformative extractions by capturing relation phrases expressed via light verb constructions.

The syntactic constraint requires relation phrases to match the POS tag pattern shown in Table 3.

TABLE 3

V | VP | VW* P
V = verb particle? adv?
W = (noun | adj | adv | pron | det)
P = (prep | particle | inf. marker)

Table 3 is a simple part-of-speech-based regular expression reduces the number of incoherent extractions like was central torpedo and covers relations expressed via light verb constructions like made a deal with. The pattern limits relation phrases to be either a simple verb phrase (e.g., invented), a verb phrase followed immediately by a preposition or particle (e.g., located in), or a verb phrase followed by a simple noun phrase and ending in a preposition or particle (e.g., has atomic weight of). If there are multiple possible matches in a sentence for a single verb, REVERB chooses the longest possible match.

Finally, if the pattern matches multiple adjacent sequences, REVERB merges them into a single relation phrase (e.g., wants to extend). This refinement enables the model to readily handle relation phrases containing multiple verbs. A consequence of this pattern is that the relation phrase must be a contiguous span of words in the sentence.

While this syntactic pattern identifies relation phrases with high precision, the extent to which it limits recall was determined by an analysis of Wu and Weld's set of 300 Web sentences. The analysis manually identified all verb-based relationships between noun phrase pairs resulting in a set of 327 relation phrases.

For each relation phrase, the analysis checked whether it satisfies the REVERB syntactic constraint. It was determined that 85% of the relation phrases do satisfy the constraints. Of the remaining 15%, some of the common cases where the constraints were violated are summarized in Table 4.

TABLE 4
Binary Verbal Relation Phrases

| | |
|---|---|
| 85% | Satisfy Constraints |
| 8% | Non-Contiguous Phrase Structure |
| | Coordination: X is produced and maintained by Y |
| | Multiple Args: X was founded in 1995 by Y |
| | Phrasal Verbs: X turned Y off |
| 4% | Relation Phrase Not Between Arguments |
| | Intro. Phrases: Discovered by Y, X . . . |
| | Relative Clauses: . . . the Y that X discovered |
| 3% | Do Not Match POS Pattern |
| | Interrupting Modifiers: X has a lot of faith in Y |
| | Infinitives: X to attack Y |

Table 4 illustrates that approximately 85% of the binary verbal relation phrases in a sample of Web sentences satisfy our constraints. Many of these cases involve long-range dependencies between words in the sentence. Attempting to cover these harder cases using a dependency parser can actually reduce recall as well as precision.

While the syntactic constraint greatly reduces uninformative extractions, it can sometimes match relation phrases that are so specific that they have only a few possible instances, even in a Web-scale corpus. Consider the sentence
The Obama administration is offering only modest greenhouse gas reduction targets at the conference.
   The POS pattern will match the phrase:

is offering only modest greenhouse gas reduction targets at (1)

Thus, there are phrases that satisfy the syntactic constraint, but are not useful relations.

To overcome this limitation, REVERB employs a lexical constraint that is used to separate valid relation phrases from over-specified relation phrases, like phrase (1). The constraint is based on the intuition that a valid relation phrase should take many distinct arguments in a large corpus. Phrase (1) will not be extracted with many argument pairs, so it is unlikely to represent a bona fide relation.

REVERB is a novel open extractor based on the constraints defined above. REVERB first identifies relation phrases that satisfy the syntactic and lexical constraints, and then finds a pair of NP arguments for each identified relation phrase. REVERB then assigns to the resulting extractions a confidence score using a logistic regression classifier trained on 1,000 random Web sentences with shallow syntactic features.

This algorithm differs in three important ways from previous methods. First, REVERB identifies relation phrase “holistically” rather than word-by-word. Second, REVERB filters potential phrases based on statistics over a large corpus (the implementation of our lexical constraint). Finally, REVERB is “relation first” rather than “arguments first,” which enables it to avoid a common error made by previous methods—confusing a noun in the relation phrase for an argument, e.g., the noun “responsibility” in “claimed responsibility for.”

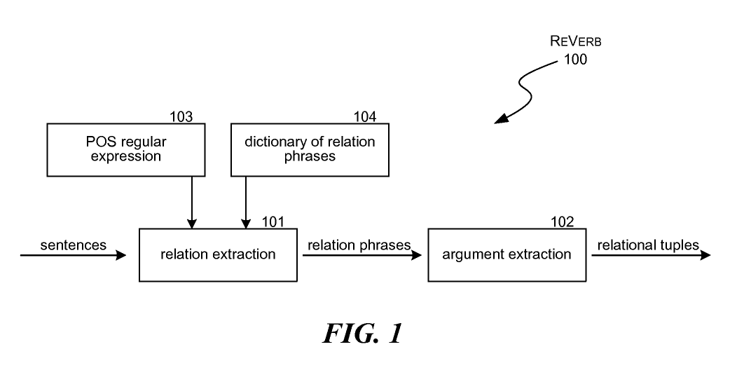

REVERB takes as input a POS-tagged and NP-chunked sentence and returns a set of (x, r, y) extraction triples. Given an input sentence s, REVERB uses the following extraction algorithm:
1. Relation Extraction: For each verb v in s, find the longest sequence of words rᵥ such that
   (1) rᵥ starts at v,
   (2) rᵥ satisfies the syntactic constraint, and
   (3) rᵥ satisfies the lexical constraint.
If any pair of matches are adjacent or overlap in s, merge them into a single match.
2. Argument Extraction: For each relation phrase r identified in Step 1, find the nearest noun phrase x to the left of r in s such that x is not a relative pronoun, WH-term, or existential “there.” Find the nearest noun phrase y to the right of r in s. If such an (x, y) pair could be found, return (x, r, y) as an extraction.
   REVERB checks whether a candidate relation phrase r satisfies the syntactic constraint by matching it against the regular expression in FIG. 1.

To determine whether rᵥ satisfies the lexical constraint, REVERB uses a large dictionary D of relation phrases that are known to take many distinct arguments. In an off-line step, D is constructed by finding all matches of the POS pattern in a corpus of 500 million Web sentences. For each matching relation phrase, its arguments are heuristically identified (as in Step 2 above). D is set to be the set of all relation phrases that take at least k distinct argument pairs in the set of extractions. In order to allow for minor variations in relation phrases, each relation phrase is normalized by removing inflection, auxiliary verbs, adjectives, and adverbs. Based on experiments on a held-out set of sentences, it was determined that a value of k=20 works well for filtering out over-specified relations. This results in a set of approximately 1.7 million distinct normalized relation phrases, which are stored in memory at extraction time.

In addition to the relation phrases, the Open IE task also requires identifying the proper arguments for these relations. Previous research and REVERB use simple heuristics such as extracting simple noun phrases or Wikipedia entities as arguments. Unfortunately, these heuristics are unable to capture the complexity of language. A large majority of extraction errors by Open IE systems are from incorrect or improperly scoped arguments. As discussed above, 65% of REVERB's errors had a correct relation phrase but incorrect arguments.

For example, from the sentence “The cost of the war against Iraq has risen above 500 billion dollars,” REVERB's argument heuristics truncate Arg1:
(Iraq, has risen above, 500 billion dollars).
   On the other hand, in the sentence “The plan would reduce the number of teenagers who begin smoking,” Arg2 gets truncated:
(The plan, would reduce the number of, teenagers).
   As described below, an argument learning component, ARGLEARNER, reduces such errors.

A goal of this linguistic-statistical analysis is to find the largest subset of language from which we can extract reliably and efficiently. To this cause, a sample of 250 random Web sentences was first analyzed to understand the frequent argument classes to answer questions such as:
What fraction of arguments are simple noun phrases?
Are Arg1s structurally different from Arg2s?
Is there typical context around an argument that can help us detect its boundaries?
   Table 5 reports on observations for frequent argument categories, both for Arg1 and Arg2.

TABLE 5

| Category | Patterns | Frequency | Frequency Arg2 |
|---|---|---|---|
| Basic NP | NN, JJ NN, etc | 65% | 60% |
| | | Chicago was founded in 1833. | Calcium prevents osteoporosis |
| Prepositional | NNPP⁺ | 19% | 18% |
| Attachments | | The forest in Brazil | Lake Michigan is one of the |
| | | is threatened by ranching. | five Great Lakes of North |
| | | | America. |
| List | NP (, NP)*, ? | 15% | 15% |
| | and/or NP | Google and Apple are | A galaxy consists of stars and |
| | | headquarteed in Silicon Valley. | stellar remnants. |
| Independent | (that\|WP\|WDT)? | 0% | 8% |
| Clause | NP VP NP | Google will acquire YouTube, | Scientists estimate that 80% of |
| | | announced the New York Times. | oil remains a treat. |
| Relative | NP (that\|WP\|WDT) | <1% | 6% |
| Clause | VP NP? | Chicago, which is located in | Most galaxies appear to be |
| | | Illinois, has three million | dwarf galaxies, which are |
| | | residents. | small. |

Table 5 illustrates a taxonomy of arguments for binary relationships. In each sentence, the argument is bolded and the relational phrase is italicized. Multiple patterns can appear in a single argument so percentages do not need to add to 100. In the interest of space, argument structures that appear in less than 5% of extractions are omitted. Upper case abbreviations represent noun phrase chunk abbreviations and part-of-speech abbreviations.

By far the most common patterns for arguments are simple noun phrases such as “Obama,” “vegetable seeds,” and “antibiotic use.” This explains the success of previous open extractors that use simple NPs. However, simple NPs account for only 65% of Arg1s and about 60% of Arg2s. This naturally dictates an upper bound on recall for systems that do not handle more complex arguments. Fortunately, there are only a handful of other prominent categories—for Arg1: prepositional phrases and lists, and for Arg2: prepositional phrases, lists, Arg2s with independent clauses, and relative clauses. These categories cover over 90% of the extractions, suggesting that handling these well will boost the precision significantly.

The analysis also explored arguments' position in the overall sentence. It was determined that that 85% of Arg1s are adjacent to the relation phrase. Nearly all of the remaining cases are due to either compound verbs (10%) or intervening relative clauses (5%). These three cases account for 99% of the relations in the sample.

An example of compound verbs is from the sentence “Mozart was born in Salzburg, but moved to Vienna in 1781,” which results in an extraction with a non-adjacent Arg1:
(Mozart, moved to, Vienna)
   An example with an intervening relative clause is from the sentence “Starbucks, which was founded in Seattle, has a new logo.” This also results in an extraction with nonadjacent Arg1:
(Starbucks, has, a new logo)

Arg2s almost always immediately follow the relation phrase. However, their end delimiters are trickier. There are several end delimiters of Arg2 making this a more difficult problem. In 58% of the extractions, Arg2 extends to the end of the sentence. In 17% of the cases, Arg2 is followed by a conjunction or function word such as “if,” “while,” or “although” and then followed by an independent clause or VP. Harder to detect are the 9% where Arg2 is directly followed by an independent clause or VP. Hardest of all is the 11% where Arg2 is followed by a preposition, since prepositional phrases could also be part of Arg2. This leads to the well-studied but difficult prepositional phrase attachment problem. For now, limited syntactic evidence (POS-tagging, NP-chunking) was used to identify arguments, though more semantic knowledge to disambiguate prepositional phrases could come in handy for this task.

The analysis of syntactic patterns reveals that the majority of arguments fit into a small number of syntactic categories. Similarly, there are common delimiters that could aid in detecting argument boundaries. This analysis lead to the development of ARGLEARNER, which is a learning-based system that uses these patterns as features to identify the arguments given a sentence and relation phrase pair.

ARGLEARNER divides this task into two subtasks—finding Arg1 and Arg2—and then subdivides each of these sub-tasks again into identifying the left bound and the right bound of each argument. ARGLEARNER employs three classifiers to this aim (FIG. 4). Two classifiers identify the left and right bounds for Arg1 and the last classifier identifies the right bound of Arg2. Since Arg2 almost always follows the relation phrase, ARGLEARNER does not need a separate Arg2 left bound classifier.

ARGLEARNER uses Weka's REPTree [Hall et al., 2009] for identifying the right boundary of Arg1 and sequence labeling CRF classifier implemented in Mallet [McCallum, 2002] for other classifiers. ARGLEARNER's standard set of features include those that describe the noun phrase in question, context around it as well as the whole sentence, such as sentence length, POS-tags, capitalization, and punctuation. In addition, for each classifier ARGLEARNER uses features suggested by the analysis above. For example, for right bound of Arg1 ARGLEARNER creates regular expression indicators to detect whether the relation phrase is a compound verb and whether the noun phrase in question is a subject of the compound verb. For Arg2 ARGLEARNER creates regular expression indicators to detect patterns such as Arg2 followed by an independent clause or verb phrase. Although these indicators will not match all possible sentence structures, they act as useful features to help the classifier identify the categories. ARGLEARNER uses several features specific to these different classifiers.

The other key challenge for a learning system is training data. Unfortunately, there is no large training set available for Open IE. So, a novel training set was built by adapting data available for semantic role labeling (SRL), which is shown to be closely related to Open IE [Christensen et al., 2011b]. It was found that a set of post-processing heuristics over SRL data can easily convert it into a form meaningful for Open IE training.

A subset of the training data adapted from the CoNLL 2005 Shared Task [Carreras and Marquez, 2005] was used. The dataset consists of 20,000 sentences and generates about 29,000 Open IE tuples. The cross-validation accuracies of the classifiers on the CoNLL data are 96% for Arg1 right bound, 92% for Arg1 left bound, and 73% for Arg2 right bound. The low accuracy for Arg2 right bound is primarily due to Arg2's more complex categories such as relative clauses and independent clauses and the difficulty associated with prepositional attachment in Arg2.

Additionally, a confidence metric was trained on a hand-labeled development set of random Web sentences. Weka's implementation of logistic regression and the classifier's weight to order the extractions were used.

The combination of REVERB for finding relation phrases and ARGLEARNER for finding arguments is referred to as R2A2.

FIG. 1 is a block diagram that illustrates components of REVERB in some embodiments. REVERB 100 includes a relation extractor 101, an argument extractor 102, a POS regular expression 103, and a dictionary of relation phrases 104. The relation extractor inputs sentences and outputs relation phrases that satisfy the syntactic constraint defined by the POS regular expression and the lexical constraint defined by the dictionary of relation phrases. The argument extractor inputs the relation phrases, identifies a left argument and a right argument for each relation phrase, and outputs a relational tuple when both a left argument and a right argument are identified.

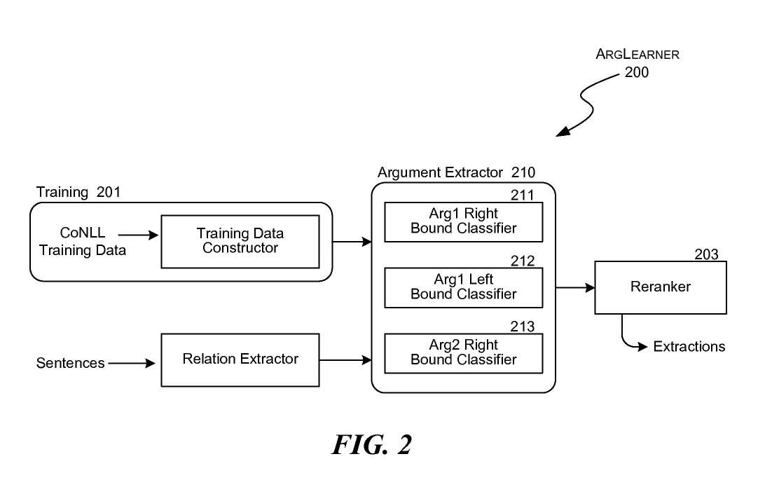

FIG. 2 is a block diagram that illustrates components of ARGLEARNER in some embodiments. ARGLEARNER 200 includes a training component 201, a relation extractor 202, a reranker 203, and an argument extractor 210. The argument extractor includes a left-argument-left-bound classifier 211, a left-argument-right-bound classifier 212, and a right-argument-right-bound classifier 213. The training component trains the classifiers. The relation extractor inputs sentences and outputs relation phrases. The argument extractor inputs the relation phrases and extracts the arguments for the relation phrases to form the relational tuples. The reranker generates a confidence metric for the relational tuples.

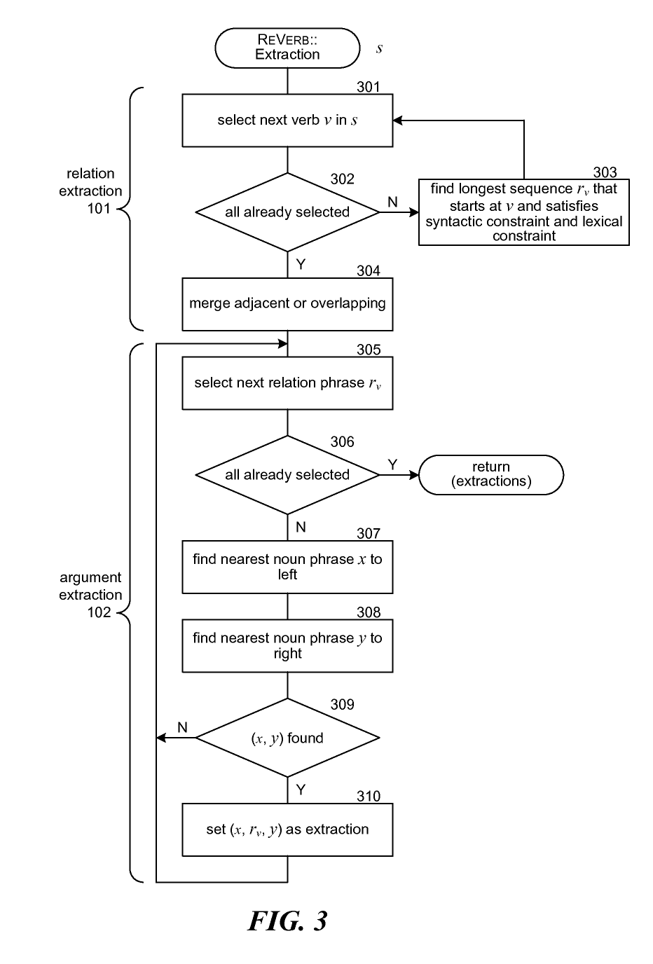

FIG. 3 is a flow diagram that illustrates the processing of an extraction component of ReVerb in some embodiments. The component inputs a sentence and outputs relational tuples. Blocks 301-304 form the relation extractor 101. In block 301, the component selects the next verb in the sentence. In decision block 302, if all the verbs have already been selected, then the component continues at block 304, else the component continues at block 303. In block 303, the component finds the longest sequence of words that starts at the verb and satisfies the syntactic and lexical constraints. The component then loops to block 301 to select the next verb. In block 304, the component merges any adjacent or overlapping relation phrases. Blocks 305-310 form the argument extractor 102. In block 305, the component selects the next relation phrase. In decision block 306, if all the relation phrases have already been selected, then the component returns the extracted relational tuples, else the component continues at block 307. In block 307, the component identifies as the left argument the nearest noun phrase to the left of the relation phrase that satisfies certain constraints. In block 308, the component identifies as the right argument the nearest noun phrase to the right of the relation phrase. In decision block 309, if a left argument and a right argument have been identified, then the component continues at block 310, else the component loops to block 305 to select the next relation phrase. In block 310 the component sets a relational tuple as the left argument, relation phrase, and right argument and then loops to block 305 to select the next relation phrase.

In the following, references are listed, which are hereby incorporated by reference.
[Allerton, 2002] David J. Allerton. Stretched Verb Constructions in English. Routledge Studies in Germanic Linguistics. Routledge (Taylor and Francis), New York, 2002.
[Banko and Etzioni, 2008] Michele Banko and Oren Etzioni. The tradeoffs between open and traditional relation extraction. In ACL'08, 2008.
[Banko et al., 2007] Michele Banko, Michael J. Cafarella, Stephen Soderland, Matt Broadhead, and Oren Etzioni. Open information extraction from the web. In IJCAI, 2007.
[Berant et al., 2011] Jonathan Berant, Ido Dagan, and Jacob Goldberger. Global learning of typed entailment rules. In ACL'11, 2011.
[Carreras and Marquez, 2005] Xavier Carreras and Lluis Marquez. Introduction to the CoNLL-2005 Shared Task: Semantic Role Labeling, 2005.
[Christensen et al., 2011a] Janara Christensen, Mausam, Stephen Soderland, and Oren Etzioni. Learning Arguments for Open Information Extraction. Submitted, 2011.
[Christensen et al., 2011b] Janara Christensen, Mausam, Stephen Soderland, and Oren Etzioni. The tradeoffs between syntactic features and semantic roles for open information extraction. In Knowledge Capture (KCAP), 2011.
[Etzioni et al., 2006] Oren Etzioni, Michele Banko, and Michael J. Cafarella. Machine reading. In Proceedings of the 21st National Conference on Artificial Intelligence, 2006.
[Fader et al., 2011] Anthony Fader, Stephen Soderland, and Oren Etzioni. Identifying Relations for Open Information Extraction. Submitted, 2011.
[Grefenstette and Teufel, 1995] Gregory Grefenstette and Simone Teufel. Corpus-based method for automatic identification of support verbs for nominalizations. In EACL'95, 1995.
[Hall et al., 2009] Mark Hall, Eibe Frank, Geoffrey Holmes, Bernhard Pfahringer, Peter Reutemann, and Ian H. Witten. The weka data mining software: An update. SIGKDD Explorations, 1(1), 2009.
[Kim and Moldovan, 1993] J. Kim and D. Moldovan. Acquisition of semantic patterns for information extraction from corpora. In Procs. of Ninth IEEE Conference on Artificial Intelligence for Applications, pages 171-176, 1993.
[Lin et al., 2010] Thomas Lin, Mausam, and Oren Etzioni. Identifying Functional Relations in Web Text. In EMNLP'10, 2010.
[McCallum, 2002] Andres McCallum. Mallet: A machine learning for language toolkit. http://mallet.cs.umass.edu, 2002.
[Riloff, 1996] E. Riloff. Automatically constructing extraction patterns from untagged text. In AAAI'96, 1996.
[Ritter et al., 2010] Alan Ritter, Mausam, and Oren Etzioni. A Latent Dirichlet Allocation Method for Selectional Preferences. In ACL, 2010.
[Ritter et al., 2011] Alan Ritter, Sam Clark, Mausam, and Oren Etzioni. Named Entity Recognition in Tweets: An Experimental Study. Submitted, 2011.
[Schoenmackers et al., 2010] Stefan Schoenmackers, Oren Etzioni, Daniel S. Weld, and Jesse Davis. Learning first-order horn clauses from web text. In EMNLP'10, 2010.
[Soderland et al., 2010] Stephen Soderland, Brendan Roof, Bo Qin, Shi Xu, Mausam, and Oren Etzioni. Adapting open information extraction to domain-specific relations. Al Magazine, 31(3):93-102, 2010.
[Soderland, 1999] S. Soderland. Learning Information Extraction Rules for Semi-Structured and Free Text. Machine Learning, 34(1-3):233-272, 1999.
[Stevenson et al., 2004] Suzanne Stevenson, Afsaneh Fazly, and Ryan North. Statistical measures of the semi-productivity of light verb constructions. In 2nd ACL Workshop on Multiword Expressions, pages 1-8, 2004.
[Wu and Weld, 2010] Fei Wu and Daniel S. Weld. Open information extraction using Wikipedia. In Proceedings of the 48th Annual Meeting of the Association for Computational Linguistics, ACL '10, pages 118-127, Morristown, N.J., USA, 2010. Association for Computational Linguistics.
[Zhu et al., 2009] Jun Zhu, Zaiqing Nie, Xiaojiang Liu, Bo Zhang, and Ji-Rong Wen. StatSnowball: a statistical approach to extracting entity relationships. In WWW'09, 2009.

From the foregoing, it will be appreciated that specific embodiments of the invention have been described herein for purposes of illustration, but that various modifications may be made without deviating from the scope of the invention. Accordingly, the invention is not limited except as by the appended claims.

I/We claim:

1. A method for extracting a relation phrase from a sentence having words, comprising:
identifying a verb in the sentence; and
identifying a phrase of the sentence starting with the identified verb that satisfies a relation phrase constraint as the relation phrase.

2. The method of claim 1 wherein the relation phrase constraint includes a syntactic constraint and a lexical constraint.

3. The method of claim 2 wherein the identified relation phrase is the longest relation phrase in the sentence that satisfies the both the syntactic constraint and lexical constraint.

4. The method of claim 3 wherein the syntactic constraint is a POS-based regular expression for reducing extraction of incoherent and uninformative relation phrases such that a relation phrase satisfies the syntactic constraint when the relation phrase matches the POS-based regular expression and wherein the lexical constraint is a dictionary of relation phrases for reducing extraction of uninformative relation phrases such that a relation phrase satisfies the lexical constraint when the relation phrase is in the dictionary.

5. The method of claim 4 wherein the POS-based regular expression is a simple verb phrase, a verb phrase followed immediately by a preposition or particle, or a verb phrase followed by a simple noun phrase and ending in a preposition or particle.

6. The method of claim 4 wherein the dictionary is created by identifying relation phrases in a corpus of sentences that match the POS-based regular expression, identifying arguments for the identified relation phrases, and selecting for the dictionary those identified relation phrases that have at least a certain number of distinct argument pairs.

7. The method of claim 1 wherein when the sentence includes multiple verbs and relation phrases are identified that are adjacent or overlap, combining the relation phrases into a single relation phrase.

8. The method of claim 1 including extracting a left argument for the identified relation phrase by identifying the nearest noun phrase in the sentence to the left of the identified relation phrase that is not a relative pronoun, WH-term, or existential “there.”

9. The method of claim 1 including extracting a right argument for the identified relation phrase as the nearest noun phrase in the sentence to the right of the identified relation phrase.

10. The method of claim 1 including extracting a left argument for the identified relation phrase by identifying a noun phrase to the left of the identified verb, extracting a set of features for the noun phrase, applying a left-argument-left-bound classifier to the set of features to determine a left bound of the left argument, and applying a left-argument-right-bound classifier to the set of features to determine a right bound of the left argument.

11. The method of claim 10 wherein the set of features includes a feature that indicates whether the sentence with that noun phrase matches a left argument regular expression.

12. The method of claim 1 including extracting a right argument for the identified relation phrase by identifying a noun phrase starting with the word immediately to the right of the relation phrase, extracting a set of features for the noun phrase, and applying a right-argument-right-bound classifier to the set of features to determine a right bound of the left argument.

13. The method of claim 12 wherein the set of features includes a feature that indicates whether the sentence with that noun phrase matches a right argument regular expression.

14. A system for identifying arguments for a relation phrase in a sentence of words, the system comprising:
a left-argument-left-bound classifier that inputs features associated with a phrase and generates a score based on those features indicating whether the phrase includes a left bound of a noun phrase of a left argument;
a left-argument-right-bound classifier that inputs features associated with a phrase and generates a score based on those features indicating whether the phrase includes a right bound of a noun phrase of a left argument;
a right-argument-right-bound classifier that inputs features associated with a phrase and generates a score based on those features indicating whether the phrase includes a right bound of a noun phrase of a right argument; and
an argument extractor that applies the left-argument-left-bound classifier, the left-argument-right-bound classifier, and the right-argument-right-bound classifier to the sentence to identify a left argument and right argument for the relation phrase such that the left argument, the relation phrase, and the right argument form the relational tuple.

15. The system of claim 14 including a relation phrase extractor that extracts a relation phrase from the sentence.

16. The system of claim 15 wherein the relation phrase extractor identifies a verb in the sentence; and
identifies the relation phrase of the sentence as a phrase in the sentence starting with the identified verb that satisfies both a syntactic constraint and a lexical constraint,
wherein a relation phrase satisfies the syntactic constraint when the relation phrase matches a POS-based regular expression for reducing extraction of incoherent and uninformative relation phrases, and
wherein a relation phrase satisfies the lexical constraint when the relation phrase is in a dictionary of relation phrases for reducing extraction of uninformative relation phrases.

17. The system of claim 14 wherein features for the left-argument-left-bound classifier and the left-argument-left-bound classifier include a feature that indicates whether the sentence with that noun phrase matches a left argument regular expression.

18. The system of claim 12 wherein the features for the right-argument-right-bound classifier include a feature that indicates whether the sentence with that noun phrase matches a right argument regular expression.
